(19) United States
(12) Patent Application Publication
(10) Pub. No.: US 2009/0325144 A1
(43) Pub. Date: Dec. 31, 2009

(54) SWINE SPERM DILUTION MEDIA CONTAINING MILK PROTEIN

(75) Inventor: Bartel Marinus Van Der Berg, Enkhuizen (NL)

Correspondence Address: BROWDY AND NEIMARK, P.L.L.C.;624 NINTH STREET, NW, SUITE 300, WASHINGTON, DC, 20001-5303, US

(73) Assignee: IMV TECHNOLOGIES, L'Aigle (FR)

(21) Appl. No.: 12/522,569

(22) PCT Filed: Jan. 3, 2008
(86) PCT No.: PCT/NL2008/000002

§ 371 Date: Jul. 9, 2009

(30) Foreign Application Priority Data
Jan. 9, 2007 (NL) 1033198

(51) Int. Cl. A01N 1/02

(52) U.S. Cl. 435/2

(57) ABSTRACT

The present invention discloses the application of a protein fraction from milk in dilution media for swine sperm. Compositions that contain this protein fraction show an improved and more economical performance. The present invention relates primarily to dilution media for swine sperm aimed at maintaining and/or improving the vitality of swine sperm cells and to be applied in the artificial insemination of swine. However, it is anticipated that this invention will be useful in reproductive techniques or processes such as artificial insemination and in vitro fertilization of other species.

This invention relates to a method for increasing and/or maintaining the viability of sperm cells in preparations for the artificial insemination of livestock. Artificial insemination (AI) has been widely accepted in the reproduction of livestock and improved reproduction in mammals. AI offers many advantages over direct mating. For example, semen collected from a single male can be used to inseminate many females, thereby reducing the number of males that are needed to maintain a population. AI also gives greater control over breeding, which results in greater reproducibility and wider and more efficient dissemination of genes or genetically determined traits. For effecting artificial insemination, semen collected from the male is first stored outside the body and then inseminated to the selected females. Therefore, the reproductive success of artificial insemination depends highly upon the satisfactory storage of semen for a reasonable long time outside the body.

In general, semen for artificial insemination is stored after it has been diluted with a suitable liquid dilution medium. The kind of dilution medium and the temperature of storage have a close connection with increasing and/or maintaining the viability of the sperm cells in the dilution medium, and thus with the fertilizing capacity thereof. The processing requirements for semen used may vary according to the species. Bovine insemination requires relatively low concentrations of sperm cells, and a suitable sample may be rapidly frozen and stored for an extended period of time without adversely affecting the fertility of the sample. In contrast, swine semen cannot be processed in this way, because greater numbers of sperm cells and larger volumes of semen or diluted semen are required to inseminate females. Swine semen is generally diluted with a suitable liquid dilution medium and cooled to a storage temperature of about 17° C. The medium serves to increase the volume of the sample to about 5 to 20 times its original volume and provides nutrients and protective substances to increase and/or maintain the viability the viability of sperm cells. Significant loss of sperm cell viability occurs after storing the semen for just a few days since the metabolism of sperm cells cannot be sufficiently inhibited. Consequently, a low conception rate is faced in artificial insemination with the use of the diluted semen stored for a period beyond five days. The relatively short time that swine sperm cells can be stored imposes considerable constraints on the use and distribution of swine sperm cells for AI.

The present invention provides improved compositions comprising liquid dilution media for swine sperm cells. Many specific liquid media formulations are known or are available commercially for increasing and/or maintaining the viability of swine sperm cells. Typically, dilution media formulations are provided in solid form (powder), and are dissolved in water for use. Standard formulations can be found in the art. For example, J. Gadea reviewed the latest knowledge on swine semen dilution media used in artificial insemination procedures. The requirements of an effective fresh semen dilution medium were discussed and currently available dilution media were compared (see http://www.engormix.com/semen_extenders_used_in_e_articles_{—}87_POR.htm). A swine sperm cell dilution medium is generally one containing salts, an energy source (e.g. glucose), one or more antibiotics and at least one buffer (e.g. 4-(2-hydroxyethyl)-1-piperazineethanesulfonic acid (HEPES)) so that the resulting solution has a pH value between 6 and 7.5. Additional components may include ethylene diamine tetraacetic acid (EDTA) and bovine serum albumin (BSA). The resulting mixture of substances, when dissolved in water, should result in a solution with an osmotic pressure of between 220 to 380 milliosmoles.

Bovine serum albumin (BSA) is a protein that is widely used in compositions for increasing and/or maintaining the viability of sperm cells. BSA stabilizes macromolecules in solution of water and is also widely used in cell culture media BSA also binds many toxic substances and stabilizes the pH of the dilution medium. The properties of BSA make it a particularly suitable protective substance for increasing and/or maintaining the viability of sperm cells. However, the use of BSA has two major drawbacks. Firstly, BSA is isolated and purified from bovine blood serum. Therefore, it poses a potential threat since the use of certain bovine products, most notably blood products, are related to the occurrence of Bovine Spongiphorm Encephalopathy (BSE). Secondly, the isolation and purification of BSA is a costly process, and does not always result in a product with reliable quality and performance. Consequently, the cost price of BSA is relatively high and makes up a major part of the cost of dilution media for swine sperm cells. So far there is no good alternative to BSA for applications in swine sperm cell dilution media. To provide the AI industry with a more economical and more appropriate replacement of BSA is a major object of the present invention.

The present invention relates to the application of protein from cow's milk—primarily as replacement for BSA—in liquid swine sperm cell dilution media. Milk protein is a relatively cheap and widely available source of protein. Milk protein is the name for a collection of proteins that can be isolated from milk, or from whey, a by-product of cheese manufactured from cow's milk. It is typically a mixture of immuno-globulins, β-lactoglobulin, α-lactalbumin, serum albumin, and many other proteins, which are soluble in their native form. The use of milk proteins in dilution media for sperm was already described in 1953 by M. R. E. J. Cassou (patent FR 1043684). Cassou described the use of fat free milk to dilute cow sperm. Of a more recent date are the extensive studies of Batellier et al. (Theriogenology 48 (1997) pp 391-410; patent EP 0969850B1). These studies deal primarily with the use of casein fractions of milk in dilution media for horse sperm. Of more recent date is the work of L. de Backer en S. Poncelet (patent NL 1024129A). In this patent the use of fat free milk powder (of brand Gloria produced by Nestlé) in dilution media for horse sperm is described. Finally, the study of M. T. Pellicer-Rubio et al. describes the use of milk containing dilution media for goat sperm (M. T. Pellicer-Rubio, T. Magallon and Y. Combarnous. Biology of Reproduction 57 (1997) 1023-1031). In contrast to the above-mentioned examples (skim) milk or casein (native phosphocasein) has not successfully been applied for preserving swine sperm cells at 17° C. Use of (skim) milk or casein has been reported though for cryopreservation of swine sperm cells. But this has not widely been applied successfully in the art.

Various components of milk are known to be both beneficial and detrimental to sperm viability. Research done in recent years showed that caseins, the major proteins of milk, appear to be responsible for the protective effect of milk on sperm in preservation media. In a similar manner as egg yolk protein, caseins decreased the binding of members of a family of lipid-binding proteins (so-called BSP proteins that induce cholesterol and phospholipid removal from the sperm membrane) to sperm and sperm lipid loss, while maintaining sperm motility and viability during storage. Caseins prevent the detrimental effect of BSP proteins on the sperm membrane during sperm preservation (A. Bergeron, Y. Brindle, P. Blondin, P. Manjunath, Biology of Reproduction 77, (2007) pp 120-126; A. Bergeron, P. Manjunath. Molecular Reproduction and Development. Volume 73, 2007, pp 1338-1344). Surprisingly, Batellier et al. found that whey protein concentrate, milk micro filtrate and ultra filtrate decreased stallion sperm survival after 48 and 96 h storage at 4 or 15° C. (F. Batellier, M. Magistrini , J. Fauquant, E. Palmer. Theriogenology 48 (1997) pp. 391-410). The use of milk serum protein or whey protein would thus be unlikely to be useful for those in the art.

Notwithstanding the successful application of milk containing or casein containing dilution media at temperatures at or around 5° C. for sperm cells of several species, such as stallion and bull, a similarly successful application for liquid dilution media for swine sperm cells has never been reported. Swine sperm cells are very different from many other species' sperm cells in that they are extremely vulnerable to cold shock. For this reason on may not assume that a sperm dilution medium that is applicable for a certain kind of mammal will also be applicable for all mammals so that a one skilled in the art may easily translate a successful dilution media from one species to another. Swine sperm cells have a different composition of the phospholipids in the membrane when compared to many other mammals. A low cholesterol/phospholipid ratio and an asymmetrical distribution of cholesterol within the membrane render swine sperm cells very susceptible to cold temperatures resulting in increased membrane permeability and loss of controlled membrane processes. Hence, rapid cooling of ejaculates to 15° C. or cooling below 15° C. results in loss of viability. To avoid this cold shock, pre-diluted ejaculates are better left at temperatures above 15° C. for several hours to induce cold resistance. In practice, semen is collected in isolated cans to avoid contact with colder surfaces and subsequent dilution is done with a dilution medium at 35-37° C. after which the semen is allowed to cool down gradually to 17° C. Further storage of diluted semen is done at 17° C., at which temperature semen metabolism is reduced, a condition necessary to extend storage time.

Storage below 12° C. has a negative effect on motility and membrane integrity in vitro (P. Vyt. Thesis. Examination and storage of liquid porcine semen. Faculty of Veterinary Medicine, Ghent University 2007).

The present invention relates to the application of protein from cow's milk—primarily aimed as replacement for BSA—in liquid swine sperm cell dilution media, in particular protein derived from whey. Application of milk protein (neither casein, nor other protein from milk or whey), to replace BSA in applications where BSA exerts its role as mentioned above and where it replaces the function of BSA, has not been reported for swine sperm cell dilution media. Surprisingly, we found a particular fraction of proteins derived from whey that showed positive properties with respect to increasing and/or maintaining the viability of swine sperm cells in a liquid dilution medium. This particular fraction of proteins derived from whey was named Porex, for sake of short description. Porex showed a superior performance over that of BSA with respect to increasing and/or maintaining the viability of swine sperm cells as shown by motility during sperm cell storage and as shown by farrowing rate and, more importantly, litter size.

Porex is produced from whey concentrate. Pertaining to the current invention is production of Porex by membrane filtration under moderate conditions. There are several methods in the art to isolate and purify water-soluble milk or whey proteins. Of these, filtration is a well-know and widely applied technique (Rombaut et al. J. Dairy Sci. 90 (2007) pp 1662-1673). Those skilled in the art of fluid dairy filtration may easily apply existing filtration techniques. To produce Porex, whey concentrate is first micro filtrated using a membrane filter with pore size of 200 micrometer. This allows all smaller bioactive protein to pass, while capturing any particulate from microbes or denatured protein. The resulting bioactive protein is further purified by ultra filtration. Ultra filtration is characterized as having a molecular weight cut-off range (MWCO) from about 3000 to 100,000 Dalton. Porex is produced using a MWCO of 10,000 Dalton. A filter with pore size of 10,000 Dalton allows minerals and lactose from the whey to pass while the bioactive protein is further concentrated. The concentrated protein is then spray dried. An absolute prerequisite to preparing Porex appropriate for the current invention is maintaining pH and moderate temperature during processing of the whey. Prior to micro filtration the whey concentrate is held at 66° C. for 3 minutes. Thereafter the temperature is lowered and kept at 22° C. Porex purified in this way is made up of mainly β-lactoglobulin, α-lactalbumin and glycomacropeptide. In addition, Porex contains also the less abundant proteins that occur in much lower concentration in milk, such as lactoferrin en lactoperoxidase. These proteins play an important role in the proposed liquid swine sperm cell dilution media. A further important characteristic of Porex is absence of free or unbound fat and minerals. Porex only contains minimal amounts of fat and minerals bound to protein.

The above-mentioned process to produce Porex leads to a highly purified unmodified and non-denatured, native protein product which is soluble in water, up to 30 gram per 100 milliliter. A typical analysis shows that dry Porex contains 97% protein, 2.3% ash, and 0.3% fat. The protein fraction contains 46±3% β-lactoglobulin, 16±2% α-lactalbumin, and 26±2% glycomacropeptide. The 10% remaining fraction contains, among the hundreds of other proteins, bovine serum albumin, lactoferrin, and lactoperoxidase.

The present invention provides improved compositions comprising dilution media for swine sperm cells containing Porex that functions in protecting the sperm cell by the concerted action of several proteins. One of these proteins is β-lactoglobulin which binds a wide range of substances among which many metals and hydrophobic molecules such as long-chain fatty acids, retinoids, steroids, and cholesterol. The binding properties of β-lactoglobulin may aid in removing oxidized lipids, that otherwise would keep the chain of oxidation running and would damage the sperm cell membrane. Another protein present in Porex is α-lactalbumin. This protein has antibacterial and anti-oxidative properties and binds metals. Glycomacropeptide has antiviral and antibacterial properties. Bovine serum albumin can bind reversibly a variety of substances. It can also sequester free radicals and inactivate various toxic lipophilic metabolites. Albumin has a high affinity for fatty acids, hematin, bilirubin and a broad affinity for small negatively charged aromatic compounds. It forms covalent adducts with pyridoxyl phosphate, cystein, glutathione, and various metals. Lactoferrin is an iron binding protein that exerts multiple effects, including acting as an antimicrobial agent. Lactoperoxidase has been identified as an antimicrobial agent. It has proven to be both bactericidal and bacteriostatic to a wide variety of micro-organisms. The concerted action of these proteins may be aided by many other proteins that are present in milk serum.

The present invention provides improved compositions comprising dilution media for swine sperm cells containing Porex that functions in protecting the sperm cell among others against many toxic substances and against oxidation. There are several toxic substances that may damage the sperm cell. These are metabolic products from dead sperm cells and other cells such as bacteria and leucocytes, toxic products produced by bacteria, trace heavy metals, and free radicals such as reactive oxygen species and reactive nitrogen species.

During spermatogenesis, after ejaculation and suspension in dilution media, and after introduction into the female genital tract, the sperm cell can be damaged by free radicals (reactive oxygen species and reactive nitrogen species). In the ejaculate, in the diluted medium and in the female tract the sperm cells face—coming from the male reproductive organ—new biochemical environments where different oxidative regimes are present. Porex serves here to protect sperm cells from oxidation. Most important, Porex protects oxidation of cell membrane components by the anti-oxidative action of several proteins among which β-lactoglobulin and lactoperoxidase.

Bacteria and bacterial toxins originate mostly from the prepuce, from semen manipulation or from the water used in the extender preparation. Also, the chemicals used to prepare dilution media are not free from bacteria and bacterial contaminants. Depending on the species, bacteria have deleterious effects on semen quality, namely depressed motility, cell death and agglutination, either by direct effect on the spermatozoa or by acidifying the environment. Swine sperm cells are extremely vulnerable to bacterial toxic products. Swine sperm cells have a different composition of the phospholipids in the membrane when compared to many other mammals which make them also more susceptible to bacterial toxins. Hydrophilic toxins may enter the cell by passing the membrane more easy. Most noteworthy, due to this unusual characteristic of swine sperm cells (being so sensitive to bacterial toxins) a swine sperm motility inhibition assay was developed into an assay useful for specific detection of mitochondria damaging toxins (D. Hoornstra, M. A. Andersson, R. Mikkola, M. S. Salkinoja-Salonen. Toxicology in Vitro, 17 (2003), pp 745-751). BSA is believed to have a positive influence on sperm survival among others due to the absorption of metabolic bacterial products from the dilution medium. In the same way, but likely more effective due to the presence of different proteins, Porex protects swine sperm cells from the action of bacterial toxins.

The present invention provides a composition comprising a sperm cell medium particularly useful for swine sperm cells. Enhanced viability of stored sperm is shown by motility determinations and—more decisively for the one skilled in the art—by assessment of farrowing rates and litter size following large-scale AI in an industrial setting.

For the purpose of exemplification, the composition of the present invention will be hereinafter illustrated by their advantageous use in the field of preserving swine sperm cells for insemination. Following is a description by way of example of methods of carrying the invention into effect. Those affiliated with artificial insemination of swine females know the art of preparing media, determination of general and progressive motility using computer assisted analysis, dilution and storage of semen, and insemination of swine females. Further necessary information is given with the three examples below.

Concentrations of components in liquid medium are expressed in terms of the number of units mass per liter. One of skill in the art would appreciate that the medium of the present invention may be prepared in any volume, and the invention is not intended to be limited to media prepared in one liter volumes. Further, the present invention is not intended to be limited to the formulation given. Other formulations containing any amount of Porex or any protein isolated from milk or from Porex, but not casein, may be applied as well.

### EXAMPLE 1

Swine semen dilution medium was prepared by adding 980 milliliter of water to: a combination of 27,4 gram glucose, 8 gram sodium citrate, 2,4 gram EDTA, 1,2 gram sodium bicarbonate, 0,4 gram potassium chloride, 0,6 gram gentamycin, 9 gram HEPES, and 1 gram Porex. This composition is named Porex dilution medium. As reference—to compare with a commercially available dilution medium—was used the widely accepted dilution medium Beltsville Thawing Solution (BTS). BTS medium was prepared by adding 980 ml water to a combination of 36,4 gr glucose, 6 gram sodium citrate, 1,25 EDTA, 1,25 sodium bicarbonate, 0,75 gram potassium chloride and 0,6 gram gentamycin. Semen was collected from 12 randomly selected, sexually mature boars. Sperm was diluted with Porex dilution medium and BTS, and general motility and progressive motility was assessed at day 1, 3, 5, 9 after dilution of the semen.

The general motility data are as follows. For BTS the %-age of sperm cells with good general motility found were 71.4, 70.4, 68.9, 47.9 for day 1, 3, 5, 9 after dilution, respectively. For the Porex dilution medium the %-age of sperm cells with good motility were 85.0, 82.9, 80.5, and 69.6 for day 1 ,3, 5, 9 after dilution, respectively.

The progressive motility data are as follows. For BTS the %-age of sperm cells with good progressive motility were 42.3, 37.8, 36.2, 24.3 for day 1, 3, 5, 9 after dilution, respectively. For the Porex dilution medium the %-age of sperm cells with good progressive motility were 76.4, 73.4, 68.5, and 57.5 for day 1, 3, 5, 9 after dilution, respectively.

### EXAMPLE 2

This example refers to semen collection, dilution and distribution carried out by a commercially AI station, and AI at 8 different swine farms. Swine semen dilution medium was prepared by adding 980 milliliter of water to a combination of 27,4 gram glucose, 8 gram sodium citrate, 2,4 gram EDTA, 1,2 gram sodium bicarbonate, 0,4 gram potassium chloride, 0,6 gram gentamycin, 9 gram HEPES, and 1 gram milk Porex. During a period of 4 weeks (May 2006) semen was collected from 28 sexually mature boars from 5 different swine races (Pietrain, York, Dalpo, Primeur, Hampshire). The sperm was diluted with the Porex sperm dilution medium and 890 females were inseminated. The average farrowing rate found was 92.0% and the average litter size found was 13.8.

### EXAMPLE 3

This example refers to semen collection, dilution and distribution carried out by a commercially AI station and AI at 8 different swine farms. Swine semen dilution medium was prepared by adding 980 milliliter of water to a combination of 27,4 gram glucose, 8 gram sodium citrate, 2,4 gram EDTA, 1,2 gram sodium bi carbonate, 0,4 gram potassium chloride, 0,6 gram gentamycin, 9 gram HEPES, and 1 gram Porex. During a period of 4 weeks (June 2006) semen was collected from 28 sexually mature boars from 5 different swine races (Pietrain, York, Dalpo, Primeur, Hampshire). The sperm was diluted with the Porex dilution medium and 930 females were inseminated. The average farrowing rate found was 91.0% and the average litter size found was 13.5.

Examples 2 and 3 give more decisive information than example 1 for those in the art since farrowing rate and litter size are the economic parameters in the swine business. Since farrowing rate and litter size vary depending on farm management, a comparison of dilution media on the same farms was done. The litter size found was 0.6 higher than the litter size found with standard BTS dilution medium as described in example 1. The average farrowing rate found was 4% higher with Porex dilution medium compared to BTS dilution medium.

After the work described in the examples mentioned above, 80.000 inseminations were done using the Porex dilution medium described in examples 2 and 3 during the period of Jul. 1, 2006 till Dec. 25, 2007. An average farrowing rate of 94.0% and an average litter size of 14.1 was found. The number of pigs born alive was on average 13.4. The number of pigs born alive is the most important economic indicator in the pig growing business. The number of pigs born alive in The Netherlands using standard dilution medium (BTS) can be taken from the data published by Agrovision based on the software Pigmanager (http://www.agrovision.nl/files/ksp20062007website01.pdf). For the period Jul. 1, 2006-Jun. 30, 2007 a farrowing rate of 86%, litter size of 13.1 and number of pigs born alive of 12.5 was found. This shows that the Porex dilution medium is a more economic dilution medium than the widely used BTS.

In accordance with the embodiment of the present invention, we have found that the viability of swine sperm cells can be increased and/or maintained by dilution in media that contain Porex so that the fertilizing capacity of the sperm cells can be increased and/or maintained for an extended period of time. Thus we have found more economical and superior dilution media by replacing BSA with milk serum protein with brand name Porex.

### CONCLUSIONS

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1-36. (canceled)

37. A composition comprising a liquid swine sperm cell dilution medium aimed at maintaining and/or increasing sperm cell vitality, containing a cow milk protein fraction named Porex of which the production is based on membrane filtration of whey concentrate.

38. A composition comprising a liquid mammalian sperm cell dilution medium aimed at maintaining and/or increasing sperm cell vitality, containing a cow milk protein fraction named Porex of which the production is based on membrane filtration of whey concentrate.

39. The composition of claim 38, wherein the cells are selected from the group consisting of equine cells, bovine cells, ovine cells and human cells.

40. The composition of claim 37, wherein the protein isolated from cow milk is other than casein.

41. A composition comprising a liquid swine sperm cell dilution medium aimed at maintaining and/or increasing sperm cell vitality containing a protein isolated from mammalian milk, other than casein.

42. A composition comprising a liquid mammalian sperm cell dilution medium aimed at maintaining and/or increasing sperm cell vitality containing a protein isolated from mammalian milk, other than casein.

43. The composition of claim 42, wherein the cells are selected from the group consisting of equine cells, bovine cells, ovine cells and human cells.

44. A method of culturing and using reproductive swine cells or groups of cells, such as swine embryos, wherein said culture or use is made in the presence of a cow milk protein fraction named Porex of which the production is based on membrane filtration of whey concentrate.

45. A method of culturing and using reproductive mammalian cells or groups of cells, wherein said culture or use is made in the presence of a cow milk protein fraction named Porex of which the production is based on membrane filtration of whey concentrate.

46. The method of claim 45, wherein the cells are selected from the group consisting of equine cells, bovine cells, ovine cells and human cells.

47. The method of claim 44, wherein the protein isolated from cow milk is other than casein.

48. A method of culturing and using reproductive swine cells or groups of cells, such as swine embryos, wherein said culture or use is made in the presence of protein isolated from mammalian milk, other than casein.

49. A method of culturing and using reproductive mammalian cells or groups of cells, wherein said culture or use is made in the presence of protein isolated from mammalian milk, other than casein.

50. The method of claim 49, wherein the cells are selected from the group consisting of equine cells, bovine cells, ovine cells and human cells.

51. The composition of claim 37, wherein the protein fraction named Porex is produced from whey concentrate by microfiltration followed by ultrafiltration while maintaining pH and moderate temperature during processing of the whey.

52. The composition of claim 38, wherein the protein fraction named Porex is produced from whey concentrate by microfiltration followed by ultrafiltration while maintaining pH and moderate temperature during processing of the whey.

53. The composition of claim 44, wherein the protein fraction named Porex is produced from whey concentrate by microfiltration followed by ultrafiltration while maintaining pH and moderate temperature during processing of the whey.

54. The composition of claim 45, wherein the protein fraction named Porex is produced from whey concentrate by microfiltration followed by ultrafiltration while maintaining pH and moderate temperature during processing of the whey.
